(19) United States
(12) Patent Application Publication
(10) Pub. No.: US 2019/0345060 A1
(43) Pub. Date: Nov. 14, 2019

(54) BENEFICIAL REUSE OF DRILL CUTTINGS

(71) Applicant: NEWALTA CORPORATION, Calgary (CA)

(72) Inventors: Suilan CHEN, Calgary (CA); Lifeng ZHAO, Calgary (CA); Vitselle MARTEZ, Calgary (CA)

(21) Appl. No.: 15/976,019

(22) Filed: May 10, 2018

(51) Int. Cl. C04B 18/04; E21B 21/06; C04B 28/04; C04B 33/132; C04B 33/04; C04B 33/30; C04B 33/32; B01J 21/06; B01J 35/00

(52) U.S. Cl. CPC C04B 18/049; E21B 21/066; C04B 28/04; C04B 33/1321; C04B 33/04; C04B 33/30; C04B 2235/656; B01J 21/063; B01J 35/004; C04B 2235/349; C04B 2235/604; C04B 2235/606; C04B 33/32

(57) ABSTRACT

Drill cuttings, initially cleaned to remove a majority of drilling fluids therefrom, but which have residual organic species, including hydrocarbons, therein are used in clean technologies to make a wide variety of ceramic and concrete products, such as tiles, slabs, blocks, bricks, pavers, decorative edgings, planters, modular barriers, embankments, medians, dividers, precast products and the like for a variety of commercial sectors. In the case of the concrete products, the organic species in the drill cuttings, including hydrocarbons, are first minimized or degraded in the drill cuttings using an oxidative process, such as photocatalytic oxidation, use of an oxidant or combinations thereof, prior to mixing the drill cuttings with cement and water, to form various concrete products. The products produced have acceptable compressive strengths and minimize or eliminate any leaching of the drill cutting contaminants therefrom. In the case of the ceramic and advanced ceramic products, the hydrocarbons and other contaminants are melted during the process of firing the ceramic products in the kiln. The kiln temperature is carefully controlled to minimize safety issues, which would otherwise be associated with the presence of at least the hydrocarbons in the products.

### FIELD

Embodiments taught herein relate to beneficial uses for waste drill cuttings and, more particularly, to methods for use of drill cuttings in producing ceramic and concrete products.

### BACKGROUND

Waste management is a significant challenge in the oil and gas industry. Drilling wastes are the second largest waste product next to produced water. Drilling of wells generate two primary types of waste drill cuttings and returned or spent drilling fluids. As a drill bit, conveyed on a drill string, advances through the formation, rock therein is broken into smaller pieces. The cuttings generally comprise the broken rock and surrounding soils including sands, clays and silts as well as organic and inorganic components. The cuttings are returned to surface by drilling fluids, which are circulated downhole during the drilling process, through the drill string and the bit, and are returned to surface through the annulus between the drill string and the wellbore. At surface, the drill cuttings are generally separated from a majority of the drilling fluid, such as by passing the returned fluid and cuttings over a shale shaker.

Drill cuttings may have hydrocarbons, heavy metals, salts, spent chemical residues, such as mineral oil, surfactants, detergents, thinners, biocides and other contaminants therein. While the hydrocarbons and spent chemical residues may degrade over time, such as through biological processes, the heavy metals and salts do not undergo biological degradation and are generally retained in the environment and can cause adverse impacts on water, soil and organisms in respective ecosystems.

Drilling fluids are typically water-based or oil-based and may include a number of different chemical additives such as rheology modifiers, clay stabilizers, proppants, biocides corrosion inhibitors, and the like. The drilling fluid flowback to surface is typically recovered and treated for reuse in preparing new drilling fluids, for conditioning of water contained therein or disposal thereof.

To date, drill cuttings have been subjected to a number of different waste management options for reclamation or disposal, depending largely on whether the operations are off-shore, onshore, the site, geographical location, type of drilling fluid, type of drilling waste, regulatory requirements and other factors.

In off-shore operations, drilling waste has generally been disposed of at sea, reinjected or transported to an on-shore facility. In on-shore operations, known waste management options generally include burial, such as on-site pit burial, earthen lined pit burial, or landfilling, disposal, such as by deep-well injection and in salt caverns, thermal processes, such as incineration or thermal de-sorption and bioremediations, such as land farming or spreading, composting and vermiculture.

Historically, waste drill cuttings were buried in lined or unlined pits or landfilled as this approach was a relatively low cost and low technology means for handling large volumes of waste drill cuttings. The disadvantages however include anaerobic conditions in pit burial, as well as seepage of leachates from waste pits into aquatic ecosystems and the management of long-term containment of landfilled sites where wastes are not destroyed.

In the case of deep well injections and placement in salt caverns, the waste can be stored long-term however deep wells and salt caverns are not readily accessible in many cases.

Bioremediation of drill cuttings, include land farming/land spreading. composting, and vermiculture, all involve natural degradation processes which aid the decomposition of organic contaminants and assist the transformation or stabilization of inorganic contaminants for forming potentially non-toxic soils and fertilizers. Designated areas of use allow the soil's naturally-occurring microbial population and its absorptive capacity to metabolize, transform and assimilate the drilling waste contaminants fairly rapidly in tropical climates. A disadvantage however is that bio-remediation-based drill cuttings waste management takes a long time. Use of predatory non-native species is not allowed in some jurisdictions such as Canada. Further, in cold climates it takes a very long time to achieve a measurable degree of success.

In the case of thermal processes, the incineration of waste drill cuttings entails controlled thermal decomposition resulting in substantially complete destruction of the contaminants and a reduction in the overall waste volume in the form of solid/ash and vapourized off-gases. Similarly, thermal desorption typically involves the direct or indirect application of heat to vaporize contaminants without incinerating the cuttings. The resultant thermally desorbed products are typically hydrocarbons, water and solids. Depending upon the type of thermal desorption process used, off-gases may be either condensed to recover residual hydrocarbons or com busted and captured using appropriate pollution control devices. The water is generally treated or disposed of. The solids are often used in road construction and may contain residual contaminants.

Drill cuttings have also been spread over gravel roads, the residual oil therein acting to suppress dust.

Known waste management options are generally economically and environmentally costly.

Where regulations permit, untreated drill cuttings have been mixed with cement, aggregate and water to produce cement-based constructions materials for use in pouring on-site well pads and the like. The use of untreated drill cuttings however is not permitted in regions where regulations are strict and there is active public scrutiny.

As land has become less available and environmental awareness and regulations have become more stringent, there has been an increasing interest in novel approaches and methods for using waste products as a resource for beneficial reuse.

Thermally treated drill cuttings, also known as reclaimed drill cuttings are known to be mixed with recycled plastics to produce plastic-based products. Thermally treated drill cuttings have also been mixed with concrete however, residual organic species, such as hydrocarbons, are known to reduce cement strength by over 25% and to cause safety concerns. Salts in concrete are known to cause cracks, fissures and spalling. Further, chlorides in salts are known to cause corrosion to structural metals used in concrete construction.

Not all current reuse options for drill cuttings earn the social license of citizens because of concerns regarding residual organic and ionic salt contaminants therein and potential transference therefrom. There is much doubt whether hydrocarbons and ionic salt contaminants are fully removed and how the residual hydrocarbons and contaminants may impact water aquifers and soil ecosystems.

Various industries are seeking clean technologies and innovative methods for generating products from materials which incorporate waste, such as drill cuttings, for beneficial use thereof. Ideally such methods should destroy, transform, or otherwise prevent contaminants from leaching therefrom and the method and products be capable of meeting or exceeding ever-increasing environmental standards and for gaining public acceptance.

Therefore, there has been an increasing interest in novel technologies and methods for turning such waste materials to a resource, through development of new products for beneficial reuse of such waste materials without further propagating negative environmental impacts. Accordingly, there is an urgent need for an environmentally responsible and cost effective method for beneficially using drill cuttings from drilling operations.

### SUMMARY

In embodiments taught herein, drill cuttings, raw or reclaimed, are utilized for generation of products for beneficial use thereof. The drill cuttings are used to make ceramic and concrete products which are useful in a variety of industries, including, but not limited to, construction and landscaping applications and for creation of recreational parks and engineered wetlands.

In one broad aspect, a method for production of molded concrete products incorporating drill cuttings having at least residual hydrocarbons therein comprises treating the drill cuttings with an oxidative process for degrading the at least residual hydrocarbons therein. The treated drill cuttings are mixed with cement and water for forming a concrete mixture. The concrete mixture is placed in molds for forming the concrete products. The molded concrete is allowed to initially cure in the molds. The molded concrete is then unmolded and allowed to finish curing for forming the concrete products.

In embodiments, the oxidative process is photocatalytic oxidation, oxidation using an oxidant, or a combination thereof in an advanced oxidation process.

In another broad aspect, a method for treatment of drill cuttings for removal of at least residual hydrocarbons therein comprises treating the drill cuttings with an oxidative process for degrading the at least residual hydrocarbons therein, wherein the oxidative process is photocatalytic oxidation, oxidation using an oxidant, or a combination thereof in an advanced oxidation process.

In embodiments, wherein the oxidative process is an advanced oxidation process, a semiconductor photocatalyst, such as nanoscale titanium dioxide, nanoscale zinc oxide, nanoscale zirconium dioxide or other suitable nano-composites, is used and the oxidant is one or more of hydrogen peroxide, ozone, atomic oxygen, permanganate, titanium oxide and the like.

The ultraviolet light is selected depending upon the photocatalyst and in the case of at least nano-titanium dioxide is at about 254 nm. The mixture is irradiated with the UV light after which an analysis is done to determine if the at least hydrocarbons are below a threshold limit, typically an environmentally acceptable limit. If the at least residual hydrocarbons are not below the threshold limit, the mixture is further irradiated. The residual contaminants may include organics including the at least residual hydrocarbons, some ionic compounds or combinations thereof.

In yet another broad aspect, a method for production of ceramic products incorporating drill cuttings having at least residual hydrocarbons therein comprises mixing the drill cuttings with a clay having a firing temperature lower than a melting temperature of the drill cuttings for forming a cuttings/clay mixture. Water to added to adjust a moisture content in the cuttings/clay mixture from about 10% to about 15%. The cuttings/clay mixture is placed into molds for forming the ceramic products. Pressure is applied for compressing the cuttings/clay mixture in the molds. The formed products are removed from the molds and allowed to dry at room temperature. The formed products are placed into a kiln for firing to produce the ceramic products. The temperature of the kiln is incrementally increased over time to a temperature at which the residual hydrocarbons are burned off and thereafter the temperature of the kiln is incrementally increased over time to the firing temperature; and after sintering, the temperature of the kiln is incrementally lowered and when sufficiently cool to permit handling of the ceramic products, the ceramic products are removed from the kiln.

Organic species, hydrocarbons and some ionic compounds are generally burnt off at temperatures below about 600° C. Incrementally increasing the temperature of the kiln to and through this range minimizes safety concerns and deformation and catastrophic damage to the products as a result of rapid heating of the hydrocarbons. Thereafter, the kiln can be raised to the firing or sintering temperature of the clay which is selected to have a firing temperature lower than a melting temperature of the drill cuttings.

In embodiments, the melting temperature of the drill cuttings is generally greater than about 1200° C. The clay firing temperature is selected to be in a range from about 900° C. to about 1200° C.

### BRIEF DESCRIPTION OF THE DRAWINGS

FIG. 1 is a graphical representation of particle size distribution in samples from two different batches of reclaimed drill cuttings, including an indication of the overlap is size distribution between the two batches;

FIG. 2 is a photograph of ceramic bricks incorporating drill cuttings produced according to an embodiment taught herein;

FIGS. 3A and 3B are photographs of ceramic tiles, incorporating drill cuttings, produced according to an embodiment taught herein and, more particularly

FIG. 3A is a photograph of ceramic tiles incorporating a first batch of drill cuttings; and

FIG. 3B is a photograph of ceramic tiles incorporating a second batch of drill cuttings;

FIGS. 4A to 4C are photographs of stepping stones made with cement mix and various amounts of untreated drill cuttings, more particularly

FIG. 4A is made with 30% untreated drill cuttings and 70% cement mix;

FIG. 4B is made with 50% untreated drill cuttings and 50% cement mix; and

FIG. 4C is made with 70% untreated drill cuttings and 30% cement mix;

FIG. 5 is a graph illustrating the effect of treatment with various amounts of titanium dioxide and hydrogen peroxide with UV irradiation on oil and grease concentrations in Batch 1 drill cuttings;

FIG. 6 is a graph illustrating the effect of treatment with various amounts of titanium dioxide and hydrogen peroxide with UV irradiation on oil and grease concentrations in Batch 2 drill cuttings;

FIG. 7 is a graph illustrating the effect of treatment with various amounts of zinc oxide and hydrogen peroxide with UV irradiation on oil and grease concentrations in Batch 1 drill cuttings;

FIG. 8 is a graph illustrating the effect of treatment with various amounts of zinc oxide and hydrogen peroxide with UV irradiation on oil and grease concentrations in Batch 2 drill cuttings; and

FIG. 9 is a photograph of a comparison of concrete cylinders incorporating treated drill cuttings produced according to an embodiment taught herein and a concrete cylinder produced without drill cuttings, shown on the left.

### DETAILED DESCRIPTION

Embodiments taught herein incorporate drill cuttings in the production of both ceramic and concrete products for use in a variety of different industries, including, but not limited to the construction and landscape industries.

### Drill Cuttings

As noted above, drill cuttings are conveyed to surface using drilling fluids and are typically first separated at surface. The separation removes a majority of the drilling fluid from the cuttings. Thereafter, the cuttings are further pre-treated by centrifugation and may be reclaimed by thermal processes, such as incineration and thermal desorption, or other suitable technologies, to remove additional drilling fluid and hydrocarbons therefrom. The thermal processes are particularly efficient for reducing or destroying organics, such as various volatile, semi-volatile and heavy hydrocarbons, and for reducing the volume and mobility of inorganics, such as metals and salts.

The drill cuttings used for testing embodiments taught herein, were reclaimed using a thermal desorption process. The reclaimed drill cuttings, containing residual contaminants, including organic species such as hydrocarbons, metals, salts and other constituents, are then used in the generation of products suitable for use in construction, landscaping and other commercial sectors.

Generally drill cuttings represent the geology of the formations in which the wellbores are drilled and the drilling fluids used to return the cuttings to surface. Prior to use in generating the beneficial products, a characterization of the drill cuttings can be performed to determine the nature and properties of the drill cuttings.

Typical characterizations include various techniques. By way of example, such techniques may include but are not limited to Elemental Dispersive Spectrometry (EDS) to determine the elemental composition and concentrations, X-ray powder diffraction (XRD) to determine the phase, crystal structure, lattice parameters or inter-planar distances and to quantify the crystallized mineral species present, assay of particle size distribution (PSD) by laser diffraction to determine the percentages of particles falling into different size ranges, analysis for Total Organic Carbon (TOC) using conventional measurement techniques to determine organic carbon and Fourier Transform Infrared Spectroscopy (FITR) following a liquid-solid extraction process to determine the amount of oil and grease, which encompasses a broad family of petroleum hydrocarbon constituents.

By way of example, EDS analysis of a representative sample of reclaimed drill cuttings, obtained from Newalta Corporation, Calgary, Alberta, Canada, suggest a large variety of minerals are present. Most readily identifiable are barite, halite, calcite and quartz. Further, elements such as carbon, calcium, oxygen, iron, sodium, magnesium, aluminum, silicon, sulfur, chlorine, potassium calcium and barium are also found.

EDS analysis of a representative grain of the reclaimed drill cuttings sample suggests organic matter is contained therein. Further, EDS analysis of a representative silt-sized grain of calcite found in the cuttings demonstrates a strong calcium peak.

Two different batches of drill cuttings, obtained from Newalta Corporation of Calgary, Alberta, Canada and used for testing of embodiments taught herein, were analyzed to determine the mineral composition.

The results are shown in Table A below:

TABLE A

| Drill Cuttings, Batch1 | | Drill Cuttings, Batch2 | |
|---|---|---|---|
| | Weight | | Weight |
| Mineral Name | Percentage (%) | Mineral Name | Percentage (%) |
| Quartz | 38.27 | Quartz | 32.04 |
| Illite | 11.31 | Illite | 16.42 |
| Plagioclase | 10.25 | Plagioclase | 9.16 |
| muscovite | 8.91 | muscovite | 9.02 |
| baryte | 7.97 | Montmorillonite | 8.12 |
| Montmorillonite | 7.70 | Albite | 7.61 |
| Albite | 5.98 | Baryte | 5.22 |
| Kaolinite | 3.61 | kaolinite | 4.30 |
| Orthoclase | 1.85 | Orthoclase | 2.49 |
| Dolomite | 1.62 | Chlorite | 2.22 |
| Chlorite | 1.19 | Anorthite | 2.12 |
| Anorthite | 1.00 | Dolomite | 0.81 |
| Rutile | 0.16 | Halite | 0.19 |
| Ankerite | 0.12 | Rutile | 0.14 |
| Pyrite | 0.04 | Pyrite | 0.13 |
| Calcite | 0.02 | Calcite | 0.02 |
| Halite | 0.001 | Ankerrite | 0.02 |
| Total | 100.0 | Total | 100.0 |

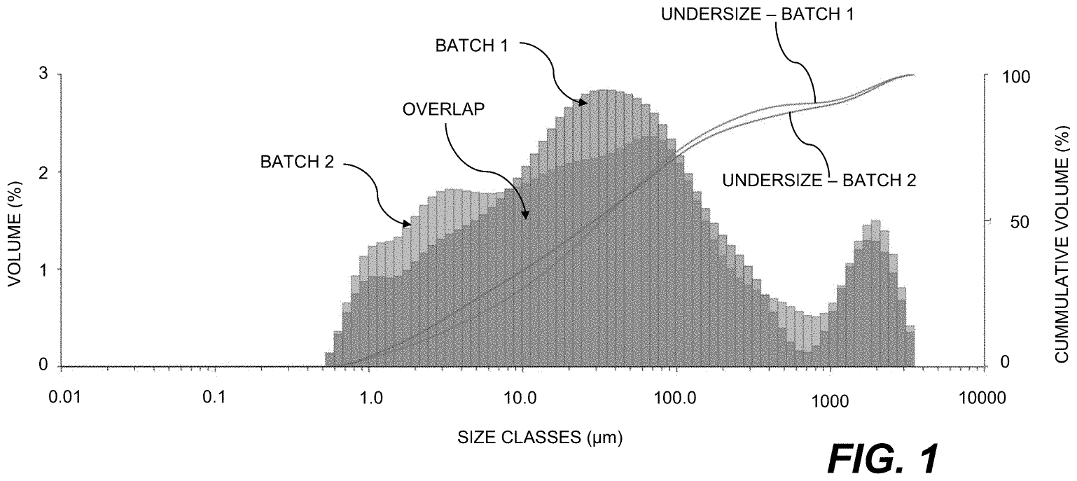

Having reference to FIG. 1 and Table B below, particle size distribution analysis of the two batches of reclaimed drill cuttings was performed using a Malvern Mastersizer 3000 laser particle size analyzer available from Malvern Panalytical Ltd. of Malvern, UK.

TABLE B

| Sample ID | Dx (10) | Dx (50) | Dx (90) |
|---|---|---|---|
| Drill cuttings Batch 1 | 2.54 μm | 32.5 μm | 689 μm |
| Drill cuttings Batch 2 | 1.92 μm | 29.3 μm | 1090 μm |

As shown in Table B, in Batch 1, about 90% of particles are smaller than about 689 μm, while in Batch 2, 90% of particles are smaller than about 1090 μm. Thus, comparatively, Batch 2 generally contains larger, coarser particles than Batch 1. Thus Batch 1 has a narrower particle size distribution range than Batch 2.

Samples of the two different batches of reclaimed drill cuttings were also analyzed for TOC and the results are shown in Table C below:

TABLE C

| Sample ID | TOC concentration (%) |
|---|---|
| Drill cuttings Batch 1 | 2.98 |
| Drill cuttings Batch 2 | 2.30 |

TOC can come from different bio-genic and anthropogenic origins, such as crude oil, residues of plants or animals, cells or tissues of soil organisms, organic and inorganic chemicals used during drilling operations, and the like. As seen in Table C, Batch 1 has a slightly higher TOC concentration than Batch 2. The difference in TOC concentration between Batch 1 and Batch 2 may reflect the differences between cuttings taken from different locations or at different stratigraphic layers in the formation, through which the drilling passes.

Dean-Stark analysis of the two different batches of cleaned drill cuttings, dried to remove moisture variation which greatly affects results, was performed to determine oil and grease concentrations, representative of the hydrocarbons present in the sample tested, as shown in Table D below.

TABLE D

| | Bitumen | Water | Solids |
|---|---|---|---|
| | Concentration | Concentration | Concentration |
| Sample ID | (%, dry weight) | (%, dry weight) | (%, dry weight) |
| Batch 1 | 0.606 | 13.2 | 99.4 |
| Batch 2 | 0.396 | 20.0 | 99.6 |

The results of the Dean Stark analysis showed the two different batches of drill cuttings had different amounts of organics, representative of the hydrocarbon concentration, water and solids. The hydrocarbon concentration in Batch 1 was found to be higher than in Batch 2.

A comparison of the concentration of C6 to C16 species were analyzed using the FTIR in Batches 1 and 2. The results are shown in Table E below.

TABLE E

| | C6-C16 |
|---|---|
| Sample ID | (%, dry weight) |
| Drill cuttings Batch 1 | 1.04% |
| Drill cuttings Batch 2 | 0.16% |

The reclaimed drill cuttings were tested using EPA Method 1315 for determination of mass transfer of inorganic analytes and general dissolved total organic carbon (TOC) therefrom. The reclaimed drill cuttings were soaked in distilled water for 10 days. Samples of eluates from each batch were then analyzed using Inductively Coupled Plasma Mass Spectrometry (ICP-MS) and Inductively Coupled Plasmas Optical Emission Spectroscopy (ICP-OES).

The results are shown in Table F below:

TABLE F

| | Drill cuttings | Drill cuttings |
|---|---|---|
| Element | Batch 1 (mg/L) | Batch 2 (mg/L) |
| Aluminum (Al) | 0.662 | 0.922 |
| Arsenic (As) | 0.0369 | 0.00661 |
| Barium (Ba) | 1.73 | 1.73 |
| Beryllium (Be) | <0.00050 | <0.00050 |
| Boron (B) | 0.191 | 0.712 |
| Cadmium (Cd) | 0.00102 | 0.00039 |
| Calcium (Ca) | 726 | 760 |
| Chromium (Cr) | 0.00128 | 0.0016 |
| Cobalt (Co) | 0.00493 | 0.00327 |
| Copper (Cu) | 0.0315 | 0.0174 |
| Iron (Fe) | 1.17 | 1.31 |
| Lead (Pb) | 0.0297 | 0.00546 |
| Magnesium (Mg) | 25.5 | 14.3 |
| Manganese (Mn) | 0.171 | 0.05 |
| Molybdenum (Mo) | 0.047 | 0.0991 |
| Nickel (Ni) | 0.0292 | 0.0234 |
| Potassium (K) | 87.2 | 43.8 |
| Selenium (Se) | 0.00399 | 0.00632 |
| Silver (Ag) | 0.000125 | 0.000106 |
| Sodium (Na) | 164 | 272 |
| Strontium (Sr) | 6.26 | 15.4 |
| Thallium (Tl) | 0.00209 | 0.000215 |
| Tin (Sn) | <0.00050 | <0.00050 |
| Titanium (Ti) | 0.0055 | 0.0139 |
| Vanadium (V) | 0.0032 | 0.0062 |
| Zinc (Zn) | 0.041 | 0.017 |
| Organics | 91.6 | 69.9 |

The combined results of the TOC and ICP leachate analysis indicated the presence of residual hydrocarbons, as well as sodium, potassium, barium, calcium, magnesium, iron and strontium in various concentrations. The presence of elemental concentrations in the leachate of the cuttings is likely due to the particular geological compositions, petroleum compounds in shales or the particular drilling mud used in upstream operations.

### Products

When incorporating waste materials, such as drill cuttings, for beneficial reuse into products, concentrations of residual hydrocarbons and contaminants in the final products are either to be reduced to levels below threshold limits, as defined applicable legal and regulatory standards, retained within the product in such a manner that the contaminants do not leach and cause toxicity therefrom, or both.

### Ceramic and Advanced Ceramic Products

In the production of an unglazed ceramic product, clay is fired within a temperature range specified for the specific clay selected. Since clays and glazes are expected to mature at specific temperatures any variance in the firing temperatures may affect one or more of ceramic strength, durability and color.

Generally clay may vary in type from unrefined clays, such as from natural deposits, to highly refined clays, typically prepared by chemical synthesis. Further, clay may include combinations of various grades of refined clay with powered or granulated non-plastic minerals such as quartz or feldspar and, as a result, have different firing temperatures.

Low fire materials typically have a firing temperature range from about 1745° F. (950° C.) to about 2012° F. (1100° C.). Medium fire materials typically have a firing temperature range from about 2124° F. (1162° C.) to about 2264° F. (1240° C.) and high fire materials typically have a firing temperature range from 2305° F. (1263° C.) to about 2336° F. (1326° C.).

If a clay material is fired at a temperature which is too low, the final product will be dry, rough, weak and unsolidified. If fired at a temperature above the specified temperature range for the clay, the product may bloat, deform and melt in the kiln.

Further, firing time affects the product. A short firing time generally results in a product that is porous and has a low density. Short to intermediate firing times result in relatively fine-grained, high strength products, typically having a pore size not larger than 0.2 mm. Long firing times result in coarse-grained products that are more creep resistant.

Ceramic processing results in products that are heat resistant, or refractory. Ceramic products that are made from highly refined natural or synthetic compositions, designed to have specific properties, are referred to as advanced ceramics. Advanced ceramics are generally classified according to application, such as electrical, magnetic, optical chemical, thermal, mechanical, biological or nuclear.

In the production of a conventional glazed ceramic product, clay is initially pre-sintered to dehydrate the clay. The temperature is then generally increased to consolidate the pre-sintered product into a dense and cohesive ceramic, making it less fragile, but retaining sufficient porosity to accept a glaze. This stage is referred to as bisque. Thereafter, a glaze is applied to the bisque and the bisque is fired to fuse the glaze to the clay and to vitrify the glaze thereon.

Glazes consist primarily of oxides and can be classified as raw glazes or frit glazes. In raw glazes, the oxides are in the form of minerals or compounds that melt readily and act as solvents for the other ingredients. Some of the more commonly used raw materials for glazes are quartz, feldspars, carbonates, borates, and zircon. Glazes generally are applied by spraying or dipping. Depending on their constituents, glazes mature at temperatures of 600° to 1500° C. (1110° to 2730° F.).

In embodiments taught herein, drill cuttings are mixed with the clay or are used alone to produce ceramic products, such as bricks or tile. Melting of the drill cuttings significantly impacts the compressive strength of the final ceramic products. The melt temperature of the drill cuttings is generally about 1200° C., due in large part to the deformation of some alkaline silicate chains in the cuttings. Thus, suitable clays are generally those which have a firing temperature between about 900° C. to about 1200° C.

Organic species, hydrocarbons and some ionic compounds, such as magnesium carbonate and lithium chloride, melt at temperatures up to about 600° C., and prior to reaching the firing temperature of the clay. Thus, it is likely that no leaching of hydrocarbon from the finished product will occur.

In an example, M2 Red Clay, available from Plainsman Clays Limited of Medicine Hat, Alberta, Canada, was selected for use according to an embodiment taught herein. M2 red clay is combined with the drill cuttings for production of ceramic materials, such as unglazed or glazed tiles and bricks.

The drill cuttings are mixed with the clay in a range from about 10% cuttings to about 100% cuttings. Generally, as the amount of drill cuttings is increased, the compressive strength decreases, as discussed in greater detail below. Thus, in embodiments, depending upon the use of the product, the amount of drill cuttings can be varied to meet design criteria and compressive strength requirements of the products end use.

Water is added, if required, to maintain water content of the mixture at about 10% to about 15%, forming a substantially semi-dry clay/cuttings mixture. In embodiments, the inherent water content of the two batches of reclaimed drill cuttings typically ranged from about 10% to about 20%.

No specific efforts are made to reduce the concentration of contaminants in the drill cuttings prior to forming the clay/cuttings mixture. The clay/cuttings mixture is placed in various types of molds suitable for making the desired product and is compressed therein. Compression of the semi-dry mixture in the molds is done using a conventional dust pressed method under pressure. Commercial dust pressing, used for products of standard sizes, is typically at range of from about 100 kg/cm² (about 1000 tonnes/m²) to about 500 kg/m² (about 5000 tonnes/m²).

In testing embodiments taught herein, tiles, having a height of about 145 mm to about 148 mm (about 5.7 inches to about 5.8 inches), a width of about 145 mm to about 148 mm (about 5.7 inches to about 5.8 inches and a depth of about 7 mm to about 9 mm (about 0.28 inches to about 0.35 inches), were compressed in the molds using about 0.1 kg/cm² (1 tonne/m²) for about 5 minutes. Bricks, being generally thicker than the tiles, were compressed in the molds with about 0.2 kg/cm² (2 tonne/m²) for about 5 minutes. Bricks formed for testing herein were about 47 mm to about 49 mm (about 1.85 inches to about 1.93 inches) in length, 47 mm to about 49 mm (about 1.85 inches to about 1.93 inches) in width and about 28 mm to about 30 mm (about 1.1 inches to about 1.2 inches) in depth. Conventional bricks are typically about 215 mm (about 8.5 inches) in length, about 102.5 mm (4 inches) in width and about 65 mm (2.6 inches) in depth. Compression pressure and compression times may vary, depending upon the type of mold, the size, thickness, scale and other factors, of the product.

After compression, the tiles or bricks are removed from the molds and allowed to dry at room temperature. Once dry to the touch, the tiles or bricks are placed in a kiln.

Advanced ceramic products are typically fired in controlled conditions in electric resistance-heated furnaces. In some embodiments, separate furnaces may be used to eliminate the organic species and contaminants before commencing with the typical firing process.

An optimum firing temperature for both the M2 clay and the cuttings is about 1098° C. An optimum bisque firing temperature, being at least at or above the temperature at which organic species, hydrocarbons and some ionic compounds are melted off, but lower than the firing temperature of the clay and the melting temperature of the drill cuttings, is about 1000° C.

While it is generally known to gradually increase the temperature of a kiln to avoid damage to conventional ceramic products, Applicant has observed however that gradually increasing the temperature over longer periods of time than for conventional firing of ceramic products avoids failures in the kiln when incorporating drill cuttings. Further, the longer the gradual increase in temperature is, particularly until at least the temperature range at which the organic species, hydrocarbons and some ionic compounds are melted off is reached, the greater the success in minimizing contaminant leaching from the ceramic products.

Thus, embodiments result in ceramic products having acceptable compressive strengths and aesthetics, without significant loss of product in the kiln which may otherwise occur due to rapid heating of the residual hydrocarbons and volatile contaminants within the dried clay/cuttings mixture.

Accordingly, in an embodiment the dried molded tiles and bricks to be glazed, formed according to the embodiment described above, are fired at a first temperature, lower than the firing temperature of the clay and the melt temperature of the drill cuttings, for forming bisque products according to the schedule outlined in Table G below:

TABLE G

| | | | | | time since |
|---|---|---|---|---|---|
| | rate | temperature | stage time | hold time | starting |
| segment # | (° C./h) | (° C.) | (h) | (h) | (h) |
| | | 21 | | | |
| 1 | 45 | 100 | 1.8 | 10 | 11.76 |
| 2 | 45 | 200 | 2.2 | 6 | 19.98 |
| 3 | 110 | 550 | 3.2 | 0 | 23.16 |
| 4 | 55 | 600 | 0.9 | 0 | 24.07 |
| 5 | 100 | 861 | 2.6 | | 26.68 |
| 6 | 50 | 1000 | 2.8 | 2 | 31.46 |
| 7 | — | 500 | 3.3 | | 34.79 |

Following the first firing according to the schedule in Table G, the bisque product can be glazed and sintered to the firing temperature according to the schedule outlined in Table H below:

TABLE H

| | Heating | | | | Time |
|---|---|---|---|---|---|
| Time | Rate | Target temp | Stage time | Hold time | since start |
| segment | (° C.) | (° C.) | (h) | (h) | (h) |
| | | 21 | | | |
| 1 | 80 | 120 | 1.2 | 0 | 1.24 |
| 2 | 200 | 959 | 4.2 | 0 | 5.43 |
| 3 | 50 | 1098 | 2.8 | 2 | 8.21 |
| 4 | — | 1037 | 0.5 | | 8.71 |
| 5 | — | 500 | 4.0 | | 12.71 |

Alternatively, bricks or tiles that are to remain unglazed, or glazed in a single firing, referred to herein as complete firing, are fired according to the schedule outlined in Table I below:

TABLE I

| | Heating | | | | Time |
|---|---|---|---|---|---|
| Time | Rate | Target temp | Stage time | Hold time | since start |
| segment | (° C.) | (° C.) | (h) | (h) | (h) |
| | | 21 | | | |
| 1 | 45 | 100 | 1.76 | 10 | 11.76 |
| 2 | 45 | 200 | 3.98 | 6 | 21.73 |
| 3 | 110 | 550 | 3.18 | 0 | 24.92 |
| 4 | 55 | 600 | 0.91 | 0 | 25.82 |
| 5 | 110 | 960 | 3.27 | 0 | 29.10 |
| 6 | 50 | 1098 | 2.76 | 2 | 33.86 |
| 7 | — | 1037 | 0.5 | | 34.36 |
| 8 | — | 500 | 4.0 | | 38.36 |

In embodiments, used to make the smaller-than-conventional bricks and the tiles, the time over which the temperature is increased for bisque firing is generally about 32 hours. The time over which the temperature is increased for a single firing for unglazed ceramics is generally about 24 hours.

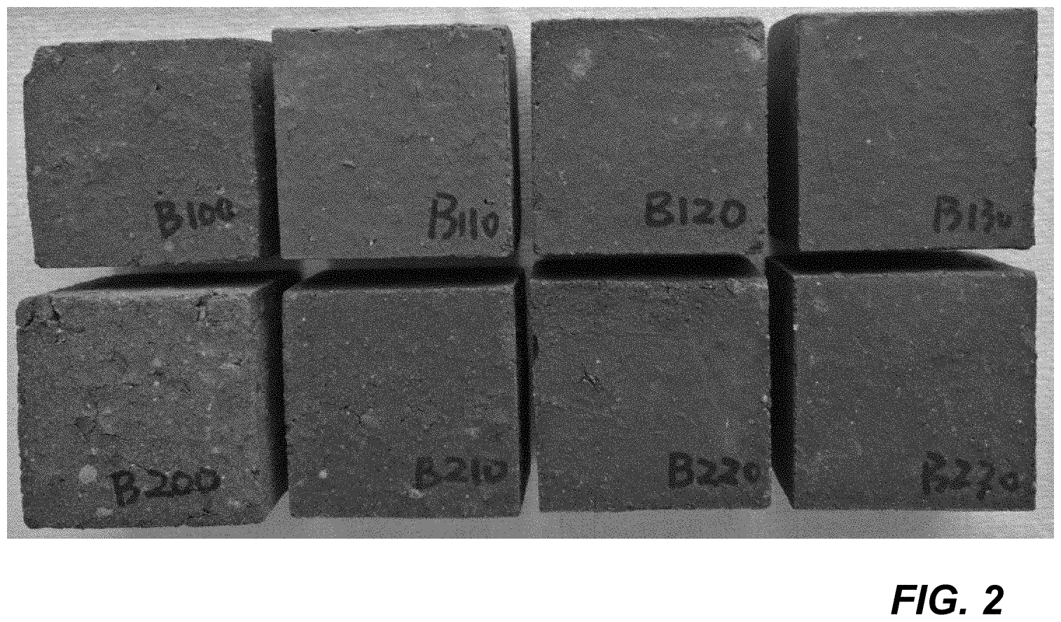

As shown in FIG. 2, a series of the smaller-than-conventional ceramic bricks were produced using different amounts of the two different batches of drill cuttings, from about 70% to about 90% mixed with about 30% to about 10% the M2 red clay. Further, ceramic bricks made of 100% drill cuttings without M2 clay were also produced. Following firing, the bricks were tested for density and compressive strength. The results as shown in Table J below:

TABLE J

| | | | Compressive | |
|---|---|---|---|---|
| | Composition | | Strength | Compressive |
| | DC - drill cuttings | Density | (N/mm2 | Strength suitable |
| ID | M2 - clay | (Kg/m³) | or MPa) | for Applications* |
| B100 | 100% DC | 2422 | 59.53 | A, B, C, D, E, F, |
| | | | | G, H |
| B110 | 90% DC; 10% M2 | 2434 | 62.41 | A, B, C, D, E, F, |
| | | | | G, H |
| B120 | 80% DC; 20% M2 | 2490 | 68.01 | A, B, C, D, E, F, |
| | | | | G, H |
| B130 | 70% DC; 30% M2 | 2388 | 64.76 | A, B, C, D, E, F, |
| | | | | G, H |
| B200 | 100% DC | 2334 | 10.98 | C |
| B210 | 90% DC; 10% M2 | 2409 | 20.75 | A, B, C, D, E, G, H |
| B220 | 80% DC; 20% M2 | 2462 | 27.19 | A, B, C, D, E, G, H |
| B230 | 70% DC; 30% M2 | 2328 | 31.53 | A, B, C, D, E, G, H |

*Applications:
A - Building brick in all weathering conditions (min. 20.7 MPa)
B - Building brick with moderate weathering (min. 17.2 MPa)
C - Building brick with negligible weathering (min. 10.3 MPa)
D - Facing brick in all weathering conditions (min. 17.2 MPa)
E - Pedestrian and light traffic paver in all weathering (min. 55.2 MPa)
F - Pedestrian and light traffic paver with moderate weathering (min. 20.7 MPa)
G - Pedestrian and light traffic paver with negligible weathering (min. 20.7 MPa)

As can be seen, compressive strength decreased with increasing amounts of drill cuttings, while density remained relatively consistent regardless the amount of drill cuttings added. Further, there was a significant difference in the compressive strengths depending upon the batch of drill cuttings used.

Having reference again to FIG. 2, Applicant observed that the surface of the brick made using higher amounts of drill cuttings appeared granular and less uniform in texture than those with lesser amounts of drill cuttings, which had a smooth texture and finish.

Applicant believes that the comparatively larger heterogeneity in the drill cuttings in Batch 2, such as the presence of an increased amount of particles having a size greater than 1000 um and comparatively higher inherent water content, likely results in a more porous product, having a comparatively lower compressive strength. Particle size distribution appears therefore to have an impact on the properties of the finished product, particularly the compressive strength and surface of the final products. The ceramic bricks as shown in FIG. 1 as well as the tiles (not shown) made using Batch 1 drill cuttings have comparatively higher compressive strength and smoother surface texture than the bricks and tiles made with the more granular Batch 2 drill cuttings.

The bricks, produced using the method as described above, were tested using EPA Method 1315 for determination of mass transfer of inorganic analytes and general dissolved organic carbon (TOC) therefrom. Samples of eluates, in which the bricks have soaked for about 10 days, were tested for the presence of a variety of elements, particularly metal ions.

The results following EPA Method 1315 testing were compared to the leachate results for the drilling cuttings alone as shown in Table K below:

TABLE K

| | Batch 1 | | | | | Batch 2 | | | | |
|---|---|---|---|---|---|---|---|---|---|---|
| | Drill | | | | | Drill | | | | |
| Element | Cuttings | | | | | Cuttings | | | | |
| (mg/L) | (Original) | B100 | B110 | B120 | B130 | (Original) | B200 | B210 | B220 | B230 |
| Aluminum | 0.662 | <0.015 | <0.015 | <0.015 | <0.015 | 0.922 | <0.015 | <0.015 | <0.015 | <0.015 |
| Arsenic | 0.0369 | 0.0591 | 0.0424 | 0.0525 | 0.0238 | 0.00661 | 0.008138 | 0.006203 | 0.005628 | 0.00708 |
| Barium | 1.73 | 0.0101 | 0.0122 | 0.0137 | 0.0202 | 1.73 | 0.0111 | 0.00972 | 0.0139 | 0.0174 |
| Beryllium | <0.00050 | <0.00050 | <0.00050 | <0.00050 | <0.00050 | <0.00050 | <0.00050 | <0.00050 | <0.00050 | <0.00050 |
| Boron | 0.191 | <0.050 | <0.050 | <0.050 | <0.050 | 0.712 | <0.050 | <0.050 | <0.050 | <0.050 |
| Cadmium | 0.00102 | <0.00025 | <0.00025 | <0.00025 | <0.00025 | 0.00039 | <0.00025 | <0.00025 | <0.00025 | <0.00025 |
| Calcium | 726 | 25.9 | 17.7 | 15.1 | 10.7 | 760 | 23.9 | 24.5 | 19.0 | 15.9 |
| Chromium | 0.00128 | <0.00050 | <0.00050 | <0.00050 | <0.00050 | 0.00160 | 0.000601 | <0.00050 | <0.00050 | <0.00050 |
| Cobalt | 0.00493 | <0.00050 | <0.00050 | <0.00050 | <0.00050 | 0.00327 | <0.00050 | <0.00050 | 0.000632 | <0.00050 |
| Copper | 0.0315 | <0.0054 | <0.0054 | <0.0054 | <0.0054 | 0.0174 | <0.0054 | <0.0054 | <0.0054 | <0.0054 |
| Iron | 1.17 | <0.15 | <0.15 | <0.15 | <0.15 | 1.31 | <0.15 | <0.15 | <0.15 | <0.15 |
| Lead | 0.0297 | <0.00025 | <0.00025 | <0.00025 | <0.00025 | 0.00546 | <0.00025 | <0.00025 | <0.00025 | <0.00025 |
| Magnesium | 25.5 | <0.50 | <0.50 | <0.50 | <0.50 | 14.3 | <0.50 | <0.50 | <0.50 | <0.50 |
| Manganese | 0.171 | <0.025 | <0.025 | <0.025 | <0.025 | 0.05 | <0.025 | <0.025 | <0.025 | <0.025 |
| Molybdenum | 0.047 | <0.012 | <0.012 | <0.012 | <0.012 | 0.0991 | <0.012 | <0.012 | <0.012 | <0.012 |
| Nickle | 0.0292 | <0.015 | <0.015 | <0.015 | <0.015 | 0.0234 | <0.015 | <0.015 | <0.015 | <0.015 |
| Potassium | 87.2 | <2.5 | <2.5 | <2.5 | <2.5 | 43.8 | <2.5 | <2.5 | <2.5 | <2.5 |
| Selenium | 0.00399 | 0.00368 | 0.00224 | 0.00278 | 0.00183 | 0.00632 | 0.00366 | 0.00083 | 0.00209 | 0.00380 |
| Silver | 0.000125 | <0.00010 | 0.000278 | <0.00010 | <0.00010 | 0.000106 | <0.00010 | <0.00010 | 0.000119 | <0.00010 |
| Sodium | 164 | <5.0 | <5.0 | <5.0 | <5.0 | 272 | <5.0 | <5.0 | <5.0 | <5.0 |
| Strontium | 6.26 | 0.108 | 0.126 | 0.121 | 0.095 | 15.4 | 0.203 | 0.245 | 0.167 | 0.167 |
| Thallium | 0.00209 | <0.00020 | 0.001035 | <0.00020 | <0.00020 | 0.000215 | <0.00020 | <0.00020 | <0.00020 | <0.00020 |
| Tin | <0.00050 | <0.00050 | <0.00050 | 0.001814 | <0.00050 | <0.00050 | 0.002147 | <0.00050 | <0.00050 | 0.000769 |
| Titanium | 0.0055 | 0.0030 | 0.0017 | 0.0016 | <0.0015 | 0.0139 | 0.0027 | 0.0029 | 0.0019 | <0.0015 |
| Vanadium | 0.0032 | 0.0190 | 0.0367 | 0.0436 | 0.0507 | 0.0062 | 0.0374 | 0.0432 | 0.0454 | 0.0519 |
| Zinc | 0.041 | <0.015 | <0.015 | <0.015 | <0.015 | 0.017 | <0.015 | <0.015 | <0.015 | <0.015 |
| Organic | 91.6 | <1.0 | <1.0 | <1.0 | <1.0 | 69.9 | <1.0 | <1.0 | <1.0 | <1.0 |
| substances | | | | | | | | | | |

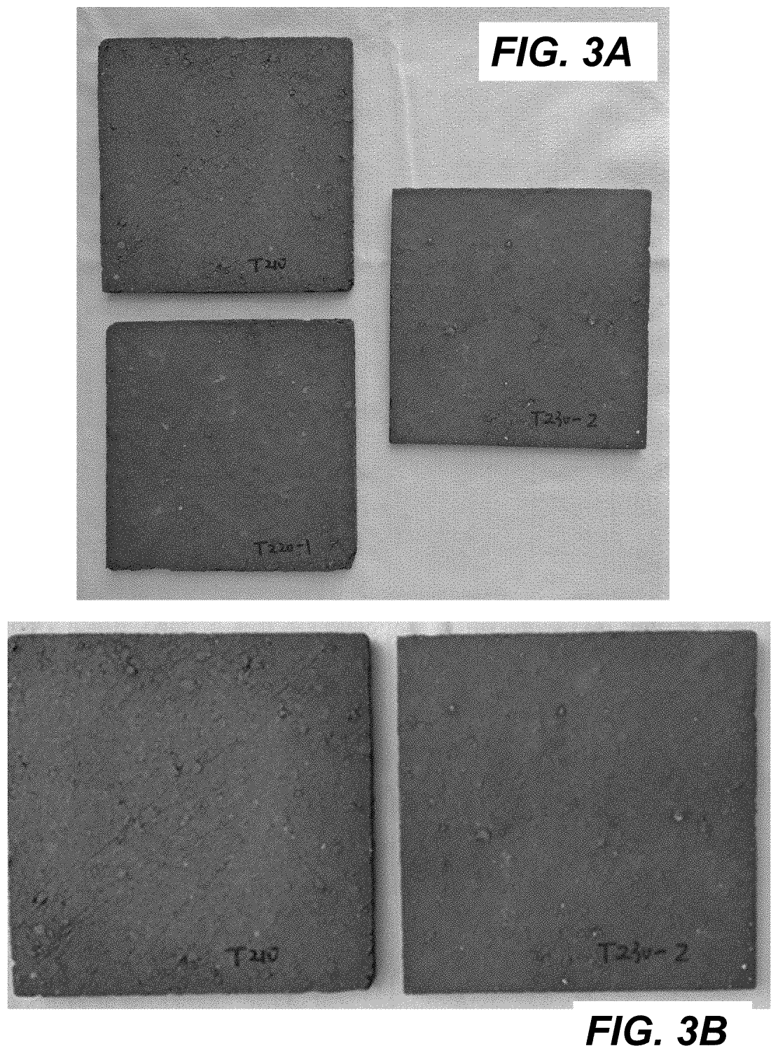

As shown in FIGS. 3A and 3B, tiles were also prepared using different amounts of the two batches of drill cuttings and M2 clay, as shown in Table L below:

TABLE L

| Tile ID | T110 | T120 | T130 | T210 | T220 | T230 |
|---|---|---|---|---|---|---|
| DC - drill | 90% DC | 80% DC | 70% DC | 90% DC | 80% DC | 70% DC |
| cuttings | | | | | | |
| M2 - clay | 10% M2 | 20% M2 | 30% M2 | 10% M2 | 20% M2 | 30% M2 |

The tiles were then tested using tested using the EPA Method 1315 for determination of mass transfer of inorganic analytes and general dissolved organic carbon (TOC) therefrom. Samples of eluates, in which the bricks have soaked for about 10 days, were tested for the presence of a variety of elements, particularly metal ions.

The results are shown in Table M below:

TABLE M

| | Batch 1 | | | | Batch 2 | | | |
|---|---|---|---|---|---|---|---|---|
| | Drill | | | | Drill | | | |
| Element | Cuttings | | | | Cuttings | | | |
| (mg/L) | (Original) | T110 | T120 | T130 | (Original) | T210 | T220 | T230 |
| Aluminum | 0.662 | <0.015 | 0.0181 | <0.015 | 0.922 | <0.015 | <0.015 | <0.015 |
| Arsenic | 0.0369 | 0.0804 | 0.0918 | 0.0371 | 0.00661 | 0.00737 | 0.00630 | 0.00932 |
| Barium | 1.73 | 0.0133 | 0.0448 | 0.0132 | 1.73 | 0.0128 | 0.0229 | 0.0233 |
| Beryllium | <0.00050 | <0.00050 | <0.00050 | <0.00050 | <0.00050 | <0.00050 | <0.00050 | <0.00050 |
| Boron | 0.191 | <0.050 | <0.050 | <0.050 | 0.712 | <0.050 | <0.050 | <0.050 |
| Cadmium | 0.00102 | 0.000331 | <0.00025 | <0.00025 | 0.00039 | <0.00025 | <0.00025 | <0.00025 |
| Calcium | 726 | 15.6 | 17.0 | 13.5 | 760 | 15.5 | 15.7 | 8.65 |
| Chromium | 0.00128 | <0.00050 | <0.00050 | <0.00050 | 0.00160 | <0.00050 | <0.00050 | <0.00050 |
| Cobalt | 0.00493 | 0.000756 | 0.000584 | 0.000939 | 0.00327 | 0.000595 | <0.00050 | <0.00050 |
| Copper | 0.0315 | <0.0054 | <0.0054 | <0.0054 | 0.0174 | <0.0054 | <0.0054 | <0.0054 |
| Iron | 1.17 | <0.15 | <0.15 | 0.173 | 1.31 | 0.385 | <0.15 | <0.15 |
| Lead | 0.0297 | <0.00025 | <0.00025 | <0.00025 | 0.00546 | <0.00025 | <0.00025 | <0.00025 |
| Magnesium | 25.5 | <0.50 | <0.50 | <0.50 | 14.3 | <0.50 | <0.50 | <0.50 |
| Manganese | 0.171 | <0.025 | <0.025 | <0.025 | 0.05 | <0.025 | <0.025 | <0.025 |
| Molybdenum | 0.047 | <0.012 | <0.012 | <0.012 | 0.0991 | <0.012 | <0.012 | <0.012 |
| Nickle | 0.0292 | <0.015 | <0.015 | <0.015 | 0.0234 | <0.015 | <0.015 | <0.015 |
| Potassium | 87.2 | <2.5 | <2.5 | <2.5 | 43.8 | <2.5 | <2.5 | <2.5 |
| Selenium | 0.00399 | 0.00087 | 0.00227 | <0.00050 | 0.00632 | 0.00365 | 0.00115 | <0.00050 |
| Silver | 0.000125 | 0.000159 | <0.00010 | 0.000569 | 0.000106 | <0.00010 | <0.00010 | 0.000146 |
| Sodium | 164 | <5.0 | <5.0 | <5.0 | 272 | <5.0 | <5.0 | <5.0 |
| Strontium | 6.26 | 0.134 | 0.167 | 0.113 | 15.4 | 0.228 | 0.271 | 0.164 |
| Thallium | 0.00209 | <0.00020 | <0.00020 | 0.000472 | 0.000215 | <0.00020 | <0.00020 | <0.00020 |
| Tin | <0.00050 | 0.00118 | 0.000789 | <0.00050 | <0.00050 | 0.00120 | 0.00087 | <0.00050 |
| Titanium | 0.0055 | <0.0015 | 0.0024 | <0.0015 | 0.0139 | 0.0016 | 0.0032 | <0.0015 |
| Vanadium | 0.0032 | 0.0574 | 0.1810 | 0.0383 | 0.0062 | 0.0775 | 0.101 | 0.0600 |
| Zinc | 0.041 | <0.015 | <0.015 | <0.015 | 0.017 | <0.015 | <0.015 | <0.015 |
| Organic | 91.6 | <1.0 | <1.0 | <1.0 | 69.9 | <1.0 | <1.0 | <1.0 |
| substances | | | | | | | | |

As can be seen, in the case of both the ceramic bricks and the ceramic tiles, the concentrations of most of the metal ions and organic substances, when compared with the original drill cuttings, were greatly reduced. In particular, the organic substances, which include at least the hydrocarbons, are reduced to less than 1.0 mg/L.

Any increase in results, such as in the case of cobalt, vanadium, tin, arsenic and others, may be due to contribution from the clay and the dyes in the glaze which are not accounted for in the original drill cutting results. Further, increases in results may be attributed to the lower limits of detection of the analytical methodologies.

In embodiments of methods for the production of ceramic products therefore, drill cuttings can be used from about 10 wt % to about 100 wt %, more particularly from about 30 wt % to about 90 wt % and yet more particularly from about 30% to about 70%, to produce ceramic products from which organic species, hydrocarbons and at least some organometallic ionic compounds do not leach or are leached a levels which meet the relevant environmental standards. The amount of the drill cuttings, the particle size distribution of the drill cuttings, the concentration of the organic species, hydrocarbons and other contaminants and the inherent water content of the drill cuttings are factors which determine the compressive strength of the product produced. Thus, drill cuttings can be selected and the amounts determined to produce a ceramic or advanced ceramic product having a particular functionality, composition, compressive strength and other characteristics as required.

Where the products are unglazed products and the firing temperature is about 1098° C., the incremental increasing of the temperature to the firing temperature comprises increasing the temperature of the kiln gradually from room temperature to about 100° C., for about 2 hours in increments of about 45° C. per hour, The temperature of the kiln is held at about the 100° C. for at least 10 hours.

The temperature of the kiln is then increased incrementally to about 200° C. for at least 4 hours in increments of about 45° C. per hour. The temperature of the kiln is held at the about 200° C. for at least 6 hours. The temperature of the kiln is incrementally increased from the about 200° C. to about 550° C. over a period of at least 3 hours in increments of about 110° C. per hour for burning off the residual hydrocarbons. The temperature of the kiln is then further incrementally increased from the about 550° C. to about 600° C. over a period of at least 1 hour in increments of about 55° C. per hour for continuing to burn off residual hydrocarbons. The temperature of the kiln is then incrementally increased from about the 600° C. to about 960° C. over a period of at least 3.5 hours in increments of about 110° C. per hour and incrementally increased from the about 960° C. to the firing temperature of about 1098° C. over a period of at least 3 hours in increments of about 50° C. The temperature of the kiln is held at the about 1098° C. for a period of at least 2 hours. Thereafter, the temperature of the kiln is lowered from the about 1098° C. to about 1037° C. over a period of at least 0.5 hours; and further lowered from the about 1037° C. to about 500° C. over a period of at least 4 hours. The kiln is then allowed to come to about room temperature. Embodiments result in a natural toned ceramic product with acceptable compressive strength.

Where the products are glazed ceramic products, the method comprises, prior to incrementally increasing the temperature of the kiln to the firing temperature: incrementally increasing the temperature of the kiln to a first pre-sintering temperature below the firing temperature for forming a bisque product. The temperature of the kiln is then incrementally lowered and when sufficiently cool to permit handling of the bisque products a glaze is applied to the bisque product. The bisque product is then returned to the kiln for sintering. Embodiments result in ceramic or advanced ceramic products with aesthetics, high compressive strengths and a range of applicability for beneficial use.

### Concrete Products

According to embodiments taught herein, concrete products, such as slabs, paving stones, cores, barrier edgings such as for curbs, decorative rock, aggregates, ornamental concrete-ware, engineered wetland blocks and other architectural, landscaping and construction products are made using a combination of drill cuttings, treated according to embodiments taught herein, concrete ingredients, such as Portland cement or equivalent thereof, and water.

Prior to mixing with the other constituents, the drill cuttings are first treated using an oxidative process, such as photocatalytic oxidation, oxidation using an oxidant alone or a combination thereof, which is termed an advanced oxidation process (AOP), to accelerate the degradation of residual hydrocarbons, at least some organometallic ionic salts and other organic species within the drill cuttings.

In the case of the AOP, the drill cuttings are first mixed with a semiconductor photocatalyst and an oxidant for forming a cuttings/photocatalyst/oxidant mixture. The semiconductor photocatalysts may include titanium dioxide (TiO₂), zinc oxide (ZnO), zirconium dioxide (ZrO₂), or other suitable nano-composites. The oxidant comprises one or more of hydrogen peroxide, ozone, atomic oxygen, permanganate, titanium oxide and the like.

Thereafter the mixture is irradiated with UV light, while mixing, until the residual organic species, hydrocarbons and organometallic ionic compounds therein are determined to be below a threshold limit. The threshold limit is an environmentally acceptable limit for at least the hydrocarbons. The UV light is generally in a range from about 100 nm to about 400 nm and is selected to be appropriate for activating the particular semiconductor photocatalyst.

In embodiments, the semiconductor photocatalyst is Degussa P-25 titanium dioxide (referred to herein as nano-TiO₂) from Acrōs Organics, a Thermo Fisher Scientific Brand, which comprises an anatase to rutile ratio of about 3:1. The nano-TiO₂ has an average particle size of about 21±5 nm. In embodiments the oxidant is reagent grade 30% wt/wt hydrogen peroxide (H₂O₂), such as obtained from Honeywell Fluka Chemicals, also a Fisher Scientific Brand. Thereafter, the cuttings are irradiated with UV light at about 254 nm to activate the nano-TiO₂ and H₂O₂ therein to degrade at least the hydrocarbons and other organic species within the drill cuttings.

Titanium dioxide particles, typically in the anatase form, catalyse the oxidation of the contaminants in the presence of UV light. Without being bound by theory, adsorption of UV light induces charge separation upon which electrons and positive holes form highly active radicals, such as hydroxyl radicals and superoxide radicals. The contaminants may be adsorbed on the nano-TiO₂ surface to react with the radicals and chemically decompose. Ideally the photocatalytic reaction results in carbon dioxide (CO₂) and water (H₂O).

In embodiments, drill cuttings are mixed with from about 0.25% to about 5% nano-TiO₂ and from about 0.25% to about 25% H₂O₂. After the addition of the nano-TiO₂ and the H₂O₂, the mixture is irradiated with UV light at 254 nm for sufficient time to decompose the organic contaminants to a level at or below a threshold acceptable to meet environmental standards. In embodiments, FITR is used to analyze the C6 to C16 species as an indication of the amount of specific concentration of these hydrocarbons. Other methods, suitable for determining hydrocarbon concentration, can be used.

In an embodiment, the mixture is irradiated for about 72 hours to form treated drill cuttings. The drill cuttings are mixed during irradiation to increase the surface area exposed to the UV light. Should the at least hydrocarbon levels in the treated drill cuttings exceed acceptable limits at 72 hours, the mixture can be irradiated until such time as the at least hydrocarbon levels drop to or below the threshold limit.

In the case of photocatalytic oxidation alone, the drill cuttings are mixed with the semiconductor photocatalyst as taught for the AOP however the oxidant is not added. The drill cuttings/photocatalyst mixture is then irradiated with UV as taught for AOP above.

In the case of oxidation using an oxidant, the drill cuttings are mixed with the oxidant alone and allowed to stand, with mixing as above, for about 48 to 72 hours. Should the at least hydrocarbon levels in the treated drill cuttings exceed acceptable limits at 72 hours, the mixture can be irradiated until such time as the at least hydrocarbon levels drop to or below the threshold limit.

Following oxidative decomposition of the organic contaminants in the drill cuttings, the treated drilling cuttings are mixed with commercial concrete ingredients, such as Portland cement or an equivalent thereof, and water, at about 8% to about 10% of the total weight of the dry ingredients. The cuttings/concrete mixture generally forms a homogeneous mixture with a paste-like consistency. Thereafter the cuttings/concrete mixture is put into a suitable mold and is degassed, such as by vibration, to release air bubbles from within the concrete. After a period of about 24 hours of initial curing at about 100% humidity and at room temperature, the molded concrete is removed from the mold and allowed to finish curing, such as for about 24 hours to about 10 days, depending upon the size of the product, at 100% humidity, such as in a water tank, at about 23±2° C.

Optionally, a cement dye powder or oxide pigment can be blended into the cuttings/concrete mixture for improving the aesthetics thereof.

Initial testing to determine the effect of different amounts of drill cuttings in concrete products produced therewith was done by mixing drill cuttings that had not been treated using an oxidative process. The mixture was hydrated with water to a moisture content of about 9% of the total weight of the dry ingredients to form the concrete mixture. The concrete mixture was then cast into molds to form stepping stones, initially cured for about 24 hours at room temperature at about 100% humidity until the stepping stones could be un-molded, allowed to fully cure as described above and then allowed to dry.

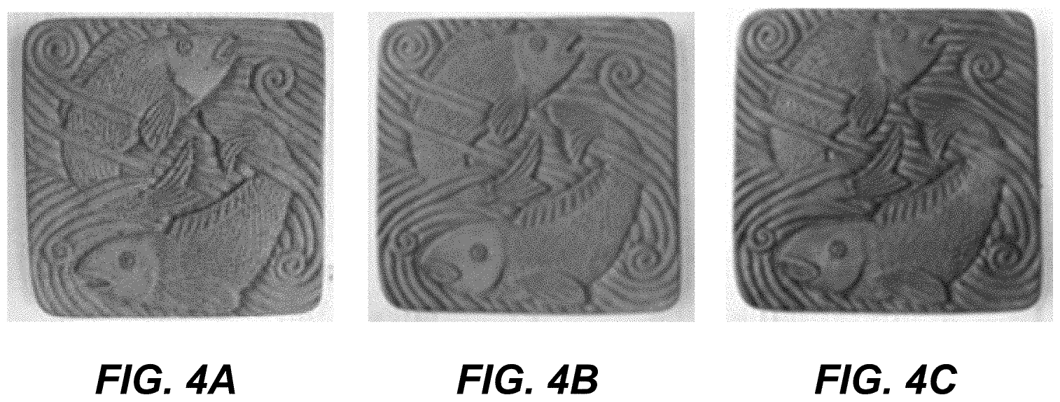

The stepping stones, as shown in FIGS. 4A-4C, were then analyzed for density and compressive strength as shown in Table N below:

TABLE N

| | Composition | | Compressive |
|---|---|---|---|
| | DC- untreated cuttings | Density | Strength |
| FIG. | C - concrete mix | (Kg/m³) | (MPa) |
| 4A | DC - 30% | 2260 | 29.8 |
| | C - 70% | | |
| 4B | DC - 50% | 2140 | 16.5 |
| | C - 50% | | |
| 4C | DC - 70% | 1990 | 7.7 |
| | C - 30% | | |

As can be seen, both density and compressive strength decreased as the percentage of untreated drill cuttings increased.

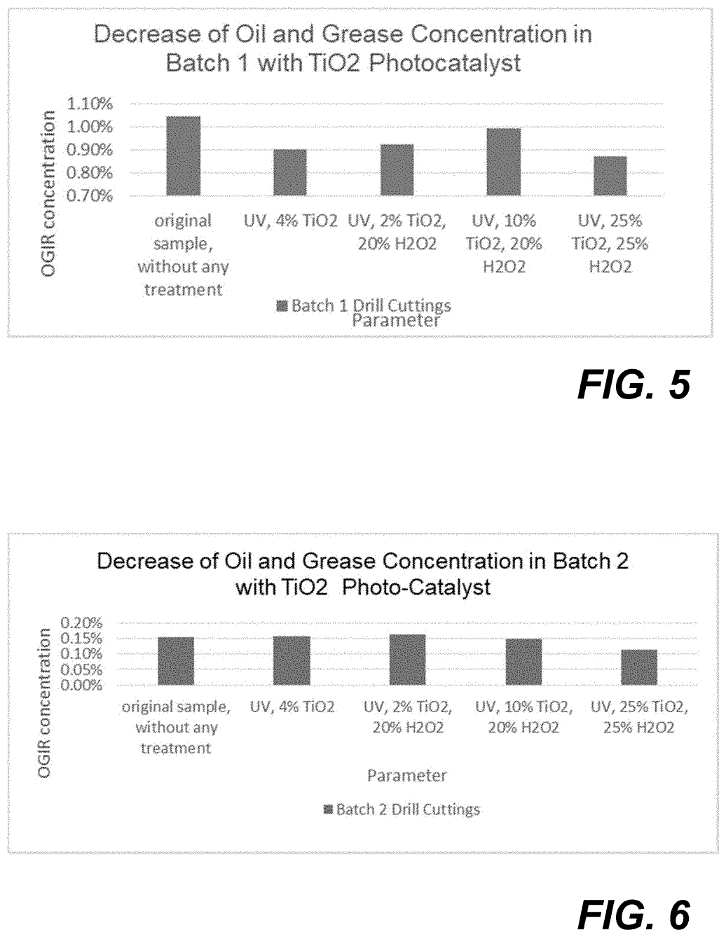

As shown in FIG. 5, reclaimed drill cuttings from Batch 1 were treated with an AOP process using nano-TiO₂ as the photocatalyst. The drill cuttings were mixed with nano-TiO₂, in a range from about 2% to about 25%, and H₂O₂, in a range from 20% to 25%. The mixture was then irradiated with UV light at about 254 nm for up to 48 hours. The greatest reduction in oil and grease contamination was observed using 25% TiO₂ and 25% H₂O₂.

As shown in FIG. 6, reclaimed drill cuttings from Batch 2 were also treated with an AOP process using nano-TiO₂ as the photocatalyst. The drill cuttings were mixed with the nano-TiO₂ in a range from about 2% to about 25% and H₂O₂, in a range from 20% to 25%. The mixture was irradiated with UV light at about 254 nm for up to 48 hours. The greatest reduction in oil and grease contamination was also observed using 25% TiO₂ and 25% H₂O₂.

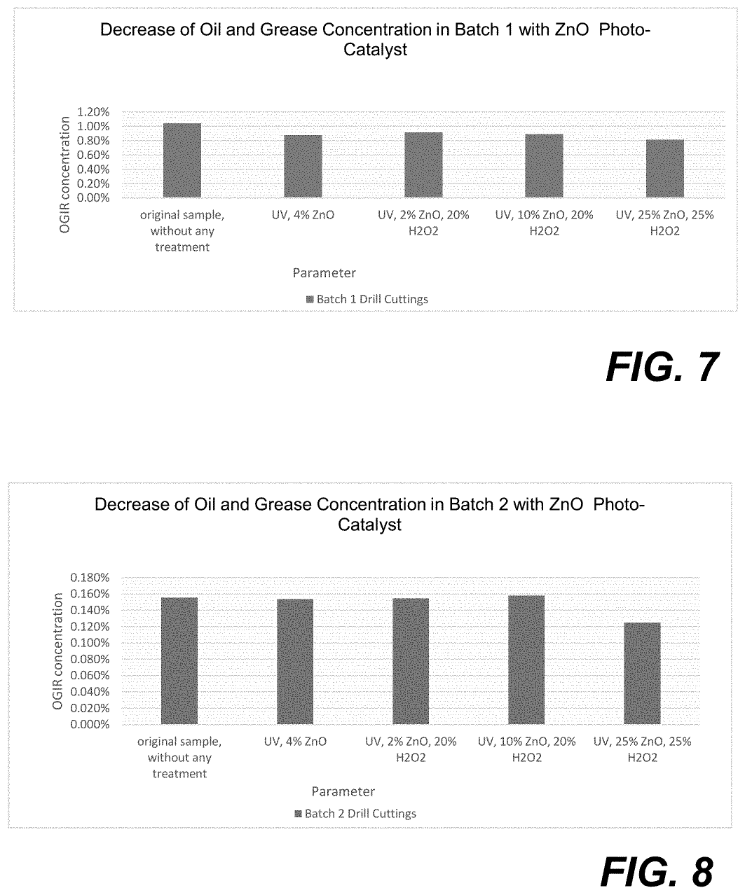

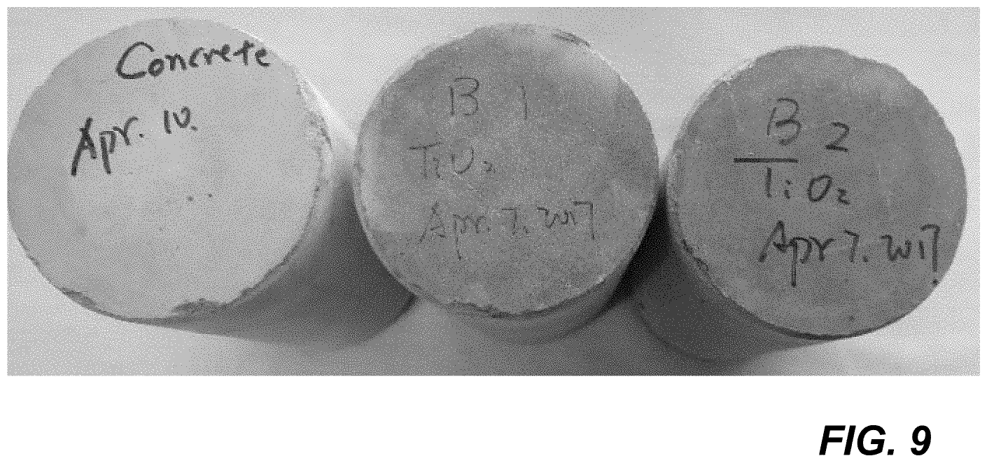

As shown in FIG. 7, reclaimed drill cuttings from Batch 1 were treated with an AOP process using nano-ZnO as the semiconductor photocatalyst. The drill cuttings were mixed with the nano-ZnO in a range from about 2% to about 25% and H₂O₂, in a range from 20% to 25%. The mixture was irradiated with UV light at about 254 nm for up to 48 hours. The greatest reduction in oil and grease contamination was observed using 25% ZnO and 25% H₂O₂.

As shown in FIG. 8, reclaimed drill cuttings from Batch 2 were also treated with an AOP process using nano-ZnO as the semiconductor photocatalyst. The drill cuttings were mixed with the nano-ZnO in a range from about 2% to about 25% and irradiated with UV light at about 254 nm for up to 48 hours. The greatest reduction in oil and grease contamination was also observed using 25% ZnO and 25% H₂O₂.

Drill cuttings were also tested using a photocatalytic oxidation process. Each of Batch 1 and Batch 2 drill cuttings were mixed with nano-ZnO in the range from about 2% to about 25% and irradiated the mixtures with UV light at about 254 nm for up to 48 hours. No oxidant was added. The results indicate that the addition of the oxidant improved the reduction of oil and grease, particularly in the case where there is a greater amount of oil and grease in the original untreated drill cuttings.

In an embodiment, drill cuttings were mixed with about 4% nano-TiO₂ and irradiated with UV light at about 254 nm over a period of about 72 hours. An oxidant was not added. About 24% of the treated drilling cuttings were mixed with about 71% of a commercially available concrete mix supplemented with 5% Portland cement. Portland cement was added to improve the compressive strength of the final product. Sufficient water was added to obtain a mixture having a water content of about 9%. The concrete mixture was then molded and cured initially for about 24 hours at room temperature and at about 100% humidity to assist with unmolding. After unmolding, the product was allowed to fully cure, such as in water for at least 10 days, and then to dry.

As shown in FIG. 5, cylindrical concrete products were made using each batch of drill cuttings (B1, B2), according to the embodiment described above, and were tested for density and compression strength. The results are shown in Table O below:

TABLE O

| | Composition | | Compressive | |
|---|---|---|---|---|
| | TDC - Treated Cuttings | | strength | |
| | C - concrete mix | Density | (N/mm2 | Suitable |
| ID | PC - Portland cement | (Kg/m3) | or MPa) | Applications |
| B1 | TDC - 23.8% | 2134 | 27.9 | Residential |
| | C - 71.4% | | | concrete* |
| | PC - 4.8% | | | Commercial |
| | | | | concrete** |
| B2 | TDC - 23.8% | 2105 | 29.33 | Residential |
| | C - 71.4% | | | concrete* |
| | PC - 4.8% | | | Commercial |
| | | | | concrete** |

*Residential concrete minimum compression strength 17 MPa
**Commercial concrete minimum compression strength 28 MPa

A cylindrical product or core was made without Portland cement and treated drill cuttings, to be used for comparison to the Batch 1 and Batch 2 products produced as described above. The drill cuttings alone, the concrete core and the Batch 1 and Batch 2 products were soaked in distilled water for about 10 days and samples of the distilled water were used to determine the mass transfer rate of elements leaching from the drill cuttings alone and the various products.

Based on the mass transfer rates, the results for the various elements are shown in Table P below:

TABLE P

| | | | Concrete | | | Concrete |
|---|---|---|---|---|---|---|
| | Batch 1 | | with | Batch 2 | | with |
| Element | Drill | Concrete | Batch 1 | Drill | Concrete | Batch 2 |
| (mg/L) | Cuttings | Only | cuttings | Cuttings | Only | cuttings |
| Aluminum | 0.662 | 0.455 | 0.356 | 0.922 | 0.455 | 0.254 |
| Arsenic | 0.0369 | <0.0053 | <0.0053 | 0.00661 | <0.0053 | <0.0053 |
| Barium | 1.73 | 0.122 | 0.682 | 1.73 | 0.122 | 0.459 |
| Beryllium | <0.00050 | <0.00050 | <0.00050 | <0.00050 | <0.00050 | <0.00050 |
| Boron | 0.191 | <0.050 | <0.050 | 0.712 | <0.050 | <0.050 |
| Cadmium | 0.00102 | <0.00025 | <0.00025 | 0.00039 | <0.00025 | <0.00025 |
| Calcium | 726 | 90.5 | 132 | 760 | 90.5 | 93.5 |
| Chromium | 0.00128 | 0.00437 | 0.00572 | 0.00160 | 0.00437 | 0.00535 |
| Cobalt | 0.00493 | <0.00050 | 0.000549 | 0.00327 | <0.00050 | <0.00050 |
| Copper | 0.0315 | <0.0054 | <0.0054 | 0.0174 | <0.0054 | <0.0054 |
| Iron | 1.17 | <0.15 | <0.15 | 1.31 | <0.15 | <0.15 |
| Lead | 0.0297 | <0.00025 | <0.00025 | 0.00546 | <0.00025 | <0.00025 |
| Magnesium | 25.5 | <0.50 | <0.50 | 14.3 | <0.50 | <0.50 |
| Manganese | 0.171 | <0.025 | <0.025 | 0.05 | <0.025 | <0.025 |
| Molybdenum | 0.047 | <0.012 | <0.012 | 0.0991 | <0.012 | <0.012 |
| Nickle | 0.0292 | <0.015 | <0.015 | 0.0234 | <0.015 | <0.015 |
| Potassium | 87.2 | 19.4 | 33.0 | 43.8 | 19.4 | 19.8 |
| Selenium | 0.00399 | 0.00204 | 0.00189 | 0.00632 | 0.00204 | <0.0050 |
| Silver | 0.000125 | 0.000212 | 0.000538 | 0.000106 | 0.000212 | <0.00010 |
| Sodium | 164 | 5.93 | 19.2 | 272 | 5.93 | 14.7 |
| Strontium | 6.26 | 0.249 | 0.938 | 15.4 | 0.249 | 0.734 |
| Thallium | 0.00209 | <0.00020 | <0.00020 | 0.000215 | <0.00020 | <0.00020 |
| Tin | <0.00050 | 0.000583 | <0.00050 | <0.00050 | 0.000583 | <0.00050 |
| Titanium | 0.0055 | 0.0090 | 0.0107 | 0.0139 | 0.0090 | 0.0108 |
| Vanadium | 0.0032 | <0.0025 | <0.0025 | 0.0062 | <0.0025 | <0.0025 |
| Zinc | 0.041 | <0.015 | <0.015 | 0.017 | <0.015 | <0.015 |
| Organic | 91.6 | 2.05 | 12.2 | 69.9 | 2.05 | 8.13 |
| substances | | | | | | |

As can be seen, for almost all species, except chromium in the concrete cores with Batch 1 and Batch 2 drilling cuttings and silver and titanium in the concrete core containing Batch 1 drill cuttings, the concentrations of the listed constituents in the eluent from the concrete products are much lower than in the eluents from drill cuttings before making them into new products. Some constituents are even lower than those in the eluent from concrete only. The increase in the concentration of chromium and titanium in particular is likely contributed by the additives, such as the cement mix used to bind the drill cuttings.

1. A method for production of molded concrete products incorporating drill cuttings having at least residual hydrocarbons therein comprises:
treating the drill cuttings with an oxidative process for degrading the at least residual hydrocarbons therein;
mixing the treated drill cuttings with cement and water for forming a concrete mixture;
placing the concrete mixture in molds for forming the concrete products;
allowing the molded concrete to initially cure in the molds;
unmolding the molded concrete; and
allowing the unmolded concrete to finish curing for forming the concrete products.

2. The method of claim 2 wherein the oxidative process is photocatalytic oxidation, oxidation using an oxidant or a combination thereof in an advanced oxidation process.

3. The method of claim 2 wherein the oxidative process is an advanced oxidative process comprising:
combining the drill cuttings with a semiconductor photocatalyst and an oxidant for forming a cuttings/photocatalyst/oxidant mixture; and
irradiating the mixture with ultraviolet light in a range of from about 100 nm to about 400 nm for activating at least the photocatalyst, while mixing, for forming treated drill cuttings.

4. The method of claim 3 wherein the photocatalyst is nanoscale titanium dioxide and the ultraviolet light is about 254 nm.

5. The method of claim 4 wherein the oxidant is one or more of hydrogen peroxide, ozone, atomic oxygen, permanganate or titanium oxide.

6. The method of claim 5 wherein the oxidant is 30% wt/wt hydrogen peroxide and wherein the cuttings/photocatalyst/oxidant mixture comprises:
from about 0.25 wt % to about 5 wt % nanoscale titanium dioxide; and
from about 0.25% to about 25% hydrogen peroxide.

7. The method of claim 6 comprising:
irradiating the cuttings/titanium dioxide/hydrogen peroxide mixture with ultraviolet light at 254 nm, while mixing, for about 72 hours for forming the treated drill cuttings;
determining if the at least hydrocarbons therein are below the threshold limit; and
if the at least hydrocarbons therein are not below the threshold limit,
continuing to irradiate the cuttings/titanium dioxide/hydrogen peroxide mixture until the at least hydrocarbons therein are below the threshold limit.

8. The method of claim 7 wherein the threshold limit comprises an environmentally acceptable limit for the at least hydrocarbons in the concrete products.

9. The method of claim 3 wherein the concrete mixture comprises from about 24% to about 42% treated drill cuttings are mixed with from about 58% to about 76% cement and sufficient water to have a moisture content in the mixture of from about 9% to 10%.

10. The method of claim 9 wherein the concrete mixture comprises an additional from about 5% to about 8% Portland cement.

11. The method of claim 1 wherein allowing the molded concrete to initially cure in the molds comprises:
curing the concrete at about 100% humidity for at least 24 hours at room temperature.

12. The method of claim 1 wherein allowing the unmolded concrete to finish curing comprises:
curing the unmolded concrete at about 100% humidity for about 10 days at about 23±2° C.

13. A method for treatment of drill cuttings for removal of at least residual hydrocarbons therein comprises:
treating the drill cuttings with an oxidative process for degrading the at least residual hydrocarbons therein,
wherein the oxidative process is photocatalytic oxidation, oxidation using an oxidant or a combination thereof in an advanced oxidation process.

14. The method of claim 13 wherein the oxidative process is an advanced oxidation process comprising:
combining the drill cuttings with a semiconductor photocatalyst and an oxidant for forming a cuttings/photocatalyst/oxidant mixture; and
irradiating the cuttings/photocatalyst/oxidant mixture with ultraviolet light from about 100 nm to about 400 nm for activating at least the photocatalyst, while mixing, for forming treated drill cuttings.

15. The method of claim 14 wherein the photocatalyst is nanoscale titanium dioxide and the ultraviolet light is at about 254 nm.

16. The method of claim 14 wherein the oxidant is one or more of hydrogen peroxide, ozone, atomic oxygen, permanganate or titanium oxide.

17. The method of claim 16 wherein the oxidant is 30% wt/wt hydrogen peroxide and wherein the cuttings/photocatalyst/oxidant mixture comprises:
from about 0.25 wt % to about 5 wt % nanoscale titanium dioxide; and
from about 0.25% to about 25% hydrogen peroxide.

18. The method of claim 17 comprising:
irradiating the cuttings/titanium dioxide/hydrogen peroxide mixture with ultraviolet light at 254 nm, while mixing, for about 72 hours for forming the treated drill cuttings;
determining if the at least hydrocarbons therein are below a threshold limit; and
if the at least hydrocarbons therein are not below the threshold limit,
continuing to irradiate the cuttings/titanium dioxide mixture until the at least hydrocarbons therein are below the threshold limit.

19. The method of claim 18 wherein the threshold limit comprises an environmentally acceptable limit for the at least hydrocarbons in the treated drill cuttings.

20. A method for production of ceramic products incorporating drill cuttings having at least residual hydrocarbons therein comprises:
mixing the drill cuttings with a clay having a firing temperature lower than a melting temperature of the drill cuttings for forming a cuttings/clay mixture;
adding water to adjust a moisture content in the cuttings/clay mixture from about 10% to about 15%;
placing the cuttings/clay mixture into molds for forming the ceramic products;
applying pressure for compressing the cuttings/clay mixture in the molds;
removing the formed products from the mold;
allowing the formed products to dry at room temperature;
placing the formed products into a kiln for firing to produce ceramic products;
incrementally increasing the temperature of the kiln over time to a temperature at which the residual hydrocarbons are burned off and thereafter
incrementally increasing the temperature of the kiln over time to the firing temperature; and after sintering;
incrementally lowering the temperature of the kiln; and when sufficiently cool to permit handling of the ceramic products;
removing the ceramic products from the kiln.

21. The method of claim 20 comprising:
mixing from about 10% to about 100% of the drill cuttings with about 90% to about 0% of the clay.

22. The method of claim 21 comprising:
mixing from about 30% to about 100% of the drill cuttings with about 70% to about 0% of the clay.

23. The method of claim 20 wherein the melting temperature of the drill cuttings is greater than about 1200° C. and the drilling temperature of the clay is in a range from about 900° C. to about 1200° C.

24. The method of claim 20 further comprising:
measuring a compressive strength of the ceramic products for determining a use thereof.
